(19) United States
(12) Patent Application Publication
(10) Pub. No.: US 2019/0081865 A1
(43) Pub. Date: Mar. 14, 2019

(54) NETWORK SYSTEM, METHOD AND COMPUTER PROGRAM PRODUCT FOR REAL TIME DATA PROCESSING

(71) Applicant: SAP SE, Walldorf (DE)

(72) Inventors: Maximilian Schrupp, Augsburg (DE); Anja Wilbert, Munchen (DE); Andreas Brain, Augsburg (DE); Georg Kreimer, Munchen (DE)

(21) Appl. No.: 15/957,851

(22) Filed: Apr. 19, 2018

(30) Foreign Application Priority Data
Sep. 13, 2017 (EP) 17001537.4

(51) Int. Cl. H04L 12/24; G06F 17/30; G06N 99/00; G06T 1/20; G06T 11/60

(52) U.S. Cl. CPC H04L 41/22; G06F 17/30377; G06N 99/005; G06T 2200/24; G06T 11/60; H04L 41/16; G06T 1/20

(57) ABSTRACT

A network system comprising multiple client devices and a central processing device is provided. The central processing device includes: a central processing unit (CPU), to receive state data derived from streaming data relating to multiple client objects and being generated at the client devices. The central processing device further includes a graphics processing unit (GPU) including a data store for storing attributes of each client object. The CPU forwards to the GPU, the received state data as update information relating to the client objects. The GPU: receives the update information from the CPU, updates the attributes in the data store using the update information, for each of the client objects to which the update information relates, performs, for each client object, rendering using the attributes of the client object stored in the data store to display, on a display device, multiple image objects corresponding to the client objects.

This application claims the benefit of and priority to European Non-Provisional Patent Application No. 17001537.4, filed 13 Sep. 2017, titled “NETWORK SYSTEM, METHOD AND COMPUTER PROGRAM PRODUCT FOR REAL TIME DATA PROCESSING” which is incorporated herein by reference in its entirety.

### BACKGROUND

In a network system, a large volume of data may be generated and exchanged by devices at various locations. Such data may be referred to as “big data”. In some circumstances, the data generated by devices at various locations may be collected and stored for further use. For example, network traffic including the big data in the network system may be monitored for ensuring smooth operation of the network system, in which case data representing states of the network traffic at different devices may be generated and collected by a central processing device (e.g. a monitoring device). Further, for example, data representing activities of users of the devices at various locations may be collected via the network by a central processing device (e.g., a server). In some circumstances, data from devices at various locations may arrive constantly at the central processing device and real time processing of the incoming data may be required.

For example, known systems for network administration may visualize states of network traffic in the network system to be monitored, which may enable interaction between the network system and a network system administrator. However, when monitoring a network system with a large volume of data adding to the network traffic, it may be challenging to visualize the data representing the states of the network traffic in real time and/or to process the data for enabling interaction by the system network administrator in real time.

### SUMMARY OF THE INVENTION

According to an aspect, the problem relates to facilitating real time processing of incoming data. The problem is solved by the features disclosed by the independent claims. Further exemplary embodiments are defined by the dependent claims.

According to an aspect, a network system comprising a plurality of client devices and at least one central processing device is provided. The at least one central processing device of the network system may comprise:
a central processing unit (CPU), configured to receive state data derived from streaming data, the streaming data relating to a plurality of client objects and being generated at one or more of the plurality of client devices, the state data relating to one or more of the plurality of client objects; and
a graphics processing unit (GPU) comprising a data store for storing one or more attributes of each client object,
wherein the CPU is further configured to:
   forward, to the GPU, the received state data as update information relating to said one or more of the plurality of client objects; and
wherein the GPU is configured to:
   receive the update information from the CPU;
   update the attributes in the data store using the update information, for each of said one or more of the plurality of client objects to which the update information relates;
   perform, for each client object, rendering using the one or more attributes of the client object stored in the data store to display, on a display device, a plurality of image objects corresponding to the plurality of client objects.

In various embodiments and examples described herein, the phrase first data being “derived from” second data may be understood that the first data is at least a part of data that can be obtained from the second data. For example, the first data “derived from” the second data may include data extracted from the second data. Additionally, the first data “derived from” the second data may include data obtained by converting at least a part of the second data.

Further, in various embodiments and examples described herein, the term “client object” may be understood as an entity, data relating to which may be processed by the central processing device. For example, in some circumstances, a client object may be one of the plurality of client devices. Additionally, in some circumstances, a client object may be a user of one or more of the plurality of client devices.

Further, in various embodiments and examples described herein, the term “attributes” may be understood as information necessary for rendering an image. The attributes may include, but are not limited to, position, color, size, animation, sound, distortion and/or texture of an image object to be displayed.

According to the network system of the above-stated aspect, since the GPU may perform the update of the attributes used for rendering, efficiency of processing for rendering may be improved as compared to a known rendering system that performs calculations for rendering at the CPU. The improved efficiency may contribute to achieving a higher frame rate for obtaining a stutter-free output.

In the network system of the above-stated aspect, for example, the GPU may be configured to perform:
said updating the attributes in the data store in parallel for each of said one or more of the plurality of client objects to which the update information relates; and/or
said rendering in parallel for each client object.

The parallel update and/or rendering by the GPU may make use of the parallel processing capability of the GPU and may further contribute to improving efficiency of the processing of rendering.

Further, in the network system of the above-stated aspect and example, the state data may include information indicating a state of each of said one or more of the plurality of client objects and the data store of the GPU may be further for storing a state of each client object.

In some examples, the plurality of client objects may be the plurality of client devices and the state of each of said one or more of the plurality of client objects may relate to network traffic to and/or from the client object.

In some other examples, the plurality of client objects may correspond to users of the plurality of client devices and the state of each of said one or more of the plurality of client objects may relate to one or more activities performed by the user corresponding to the client object.

Regarding the aspect and examples as stated above, the CPU may be further configured to:
perform said forwarding of the received state data as the update information to the GPU in a predetermined time interval; and
include, in the update information to be forwarded to the GPU, for each of said one or more of the plurality of client objects, the information indicating the state of the client object and having been received latest during the predetermined time interval.

Regarding the aspect and various examples as stated above, each of the plurality of image objects to be displayed on the display device may comprise a plurality of polygons:
wherein the one or more attributes of each client object may include one or more of the following: position, color, size, animation, sound, distortion, texture; and
wherein the GPU may be further configured to, when performing said rendering, determining positions and/or orientations of the plurality of polygons of each of the plurality of image objects.

Regarding the aspect and various examples as stated above, the network system may further comprise a virtual reality headset, wherein the display device may be comprised in the virtual reality headset.

Regarding the aspect and various examples as stated above, the network system may further comprise:
an artificial intelligence (AI) engine, configured to provide a user of the at least one central processing device with information suggesting an action to be taken by the user based on the state data received by the CPU;
wherein the at least one central processing device may further comprise:
   an input device configured to receive one or more inputs from the user of the at least one central processing device; and
wherein the AI engine may be further configured to learn which action to suggest to the user, based on the one or more inputs from the user in the past based on various machine learning algorithms.

According to another aspect, a method is provided. The method may comprise:
receiving, by a central processing unit, CPU, state data derived from streaming data;
forwarding, by the CPU to a graphics processing unit, GPU, comprising a data store for storing one or more attributes, the received state data as update information;
receiving, by the GPU, the update information from the CPU;
updating, by the GPU, the attributes in the data store using the update information;
performing, by the GPU, rendering using the one or more attributes to display, on a display device, a plurality of image objects.

Specifically, according to the before aspect or a new aspect, the method may comprise:
receiving, by a central processing unit, CPU, state data derived from streaming data, the streaming data relating to a plurality of client objects and being generated at one or more of a plurality of client devices, the state data relating to one or more of the plurality of client objects;
forwarding, by the CPU to a graphics processing unit, GPU, comprising a data store for storing one or more attributes of each client object, the received state data as update information relating to said one or more of the plurality of client objects;
receiving, by the GPU, the update information from the CPU;
updating, by the GPU, the attributes in the data store using the update information, for each of said one or more of the plurality of client objects to which the update information relates;
performing, by the GPU, for each client object, rendering using the one or more attributes of the client object stored in the data store to display, on a display device, a plurality of image objects corresponding to the plurality of client objects.

In the method of the above-stated aspect, for example, said updating by the GPU of the attributes in the data store may be performed in parallel for each of said one or more of the plurality of client objects to which the update information relates; and/or said rendering by the GPU may be performed in parallel for each client object.

Further, in the method of the above-stated aspect and embodiments and/or examples, the state data may include information indicating a state of each of said one or more of the plurality of client objects and the data store of the GPU may be further for storing a state of each client object.

In some embodiments and/or examples, the plurality of client objects may be the plurality of client devices and the state of each of said one or more of the plurality of client objects may relate to network traffic to and/or from the client object.

In some other embodiments and/or examples, the plurality of client objects may correspond to users of the plurality of client devices and the state of each of said one or more of the plurality of client objects may relate to one or more activities performed by the user corresponding to the client object.

Regarding the method according to the above-stated aspect and embodiments and/or examples, the CPU may perform said forwarding of the received state data as the update information to the GPU in a predetermined time interval; and the CPU may include, in the update information to be forwarded to the GPU, for each of said one or more of the plurality of client objects, the information indicating the state of the client object and having been received latest during the predetermined time interval.

Regarding the method according to the above-stated aspect and embodiments and/or examples, each of the plurality of image objects to be displayed on the display device may comprise a plurality of polygons;
wherein the one or more attributes of each client object may include one or more of the following: position, color, size, distortion, animation, sound, texture; and
wherein, when performing said rendering, the GPU may determine positions and/or orientations of the plurality of polygons of each of the plurality of image objects.

Further, the method according to the above-stated aspect and embodiments and/or examples may further comprise:
providing, by an artificial intelligence (AI) engine, a user with information suggesting an action to be taken by the user based on the state data received by the CPU;
receiving, by an input device, one or more inputs from the user; and
learning, at the AI engine, which action to suggest to the user, based on the one or more inputs from the user received in the past based on machine learning algorithms.

According to yet another embodiment and/or an aspect, a computer program product is provided. The computer program product may comprise computer-readable instructions that, when loaded and run on a computer, cause the computer to perform the steps of the method according to the aspect and various examples as stated above.

The subject matter described in the application can be implemented as a method or as a system, possibly in the form of one or more computer program products. The subject matter described in the application can be implemented in a data signal or on a machine readable medium, where the medium is embodied in one or more information carriers, such as a CD-ROM, a DVD-ROM, a semiconductor memory, or a hard disk. Such computer program products may cause a data processing apparatus to perform one or more operations described in the application.

In addition, subject matter described in the application can also be implemented as a system including a processor, and a memory coupled to the processor. The memory may encode one or more programs to cause the processor to perform one or more of the methods described in the application. Further subject matter described in the application can be implemented using various machines.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 shows a block diagram showing a network system.

FIG. 2 shows a block diagram showing a central processing device, artificial intelligence (AI) engine and a virtual reality (VR) system.

FIG. 3 shows a process performed by the central processing device.

FIGS. 4A to 4F show exemplary images that are displayed on a display device by the central processing device.

FIGS. 5A to 5F show exemplary images that are displayed on a display device by the central processing device.

FIG. 6 shows an exemplary hardware configuration of a computer that is used to implement the system described herein.

### DETAILED DESCRIPTION

Embodiments of techniques related to Network system, method and computer program product for real time data processing are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

In the following text, a detailed description of embodiments and/or examples will be given with reference to the drawings. It should be understood that various modifications to the embodiments and/or examples may be made. In particular, one or more elements of one embodiment and/or example may be combined and used in other embodiments and/or examples to form new embodiments and/or examples.

In the exemplary embodiments and various examples described herein, live streamed data of multiple events may be processed and displayed in a virtual reality (VR) environment. The exemplary embodiments and various examples may use various human interface devices (HIDs) to enable user interaction with data in the VR environment. The processed data may be virtually rendered into VR environment. With a network system according to the exemplary embodiments and various examples, a user can get a different view and understanding on the overall displayed data leveraging the spatial comprehension of the user. The user can interact and manipulate data in real time and train an individually interacting artificial intelligence (AI) mechanism or engine, for future decisions with regards to the data which is enabled by several machine learning algorithms.

In the following, an exemplary embodiment relating to monitoring network traffic in a network system will be described first. It should be noted, however, embodiments are not limited to monitoring of network traffic, as will be described later.

Network

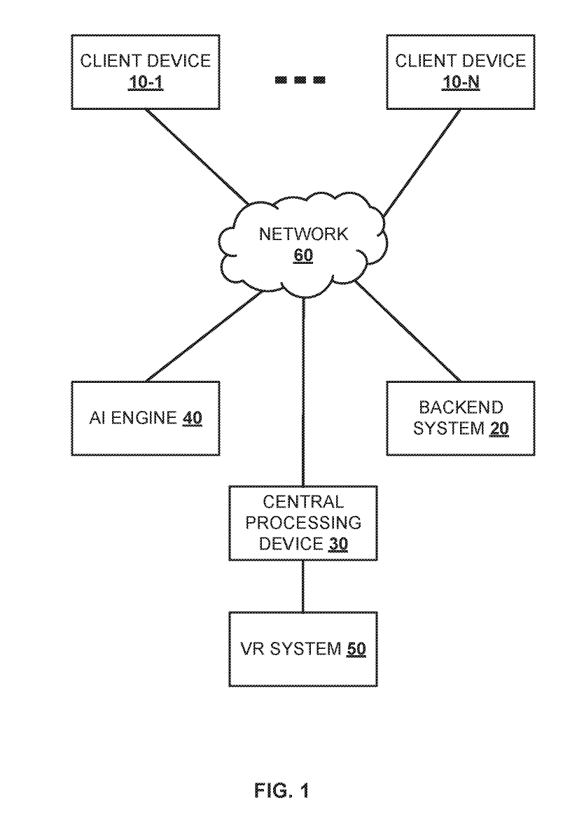

FIG. 1 shows an example of a network system. As shown in FIG. 1, the exemplary network system may comprise a plurality of client devices 10-1, . . . , 10-N (hereinafter, also referred to simply as “client device 10” or “client devices 10”), backend system 20, at least one central processing device 30 and AI engine 40, which are connected with each other via network 60. The network 60 may include the Internet and/or one or more intranets. The client devices 10, backend system 20, central processing device 30 and AI engine 40 may be connected to network 60 via a wireless and/or wired connection.

In the exemplary network system shown in FIG. 1, client devices 10 may generate streaming data relating to a plurality of client objects. A client object may be an entity, data relating to which, may be processed by central processing device 30. In the exemplary embodiment for monitoring network traffic, a client object may be one of client devices 10 and central processing device 30 may process data representing a state of network traffic to and/or from client device 10, as the client object. Upon pre-processing, the streaming data generated by client devices 10 may be sent to central processing device 30 for further processing.

In an embodiment, client devices 10 may each be a computer such as a personal computer, a server computer, a workstation, etc. In some examples, at least one of client devices 10 may be a mobile device such as mobile phone (e.g. smartphone), a tablet computer, a laptop computer, a personal digital assistant (PDA), etc. In some examples, at least one of the client devices 10 may be a network device such as a router, a hub, a bridge, etc. The client device 10 may be present in different locations and one or more of client devices 10 may change its or their location(s) over time (e.g., in particular in case the client device 10 is a mobile device). The backend system 20 may be a computer system that is configured to implement a software application that uses the data processed by central processing device 30. The backend system 20 may define specific type and/or use of the data processed by central processing device 30 and tasks to be performed by a user of central processing device 30 with respect to the data processed by central processing device 30.

In the exemplary embodiment, backend system 20 may provide a software application for monitoring network traffic in the exemplary network system. For example, backend system 20 may determine occurrences of network failures based on the data that represents states of the network traffic, notify a user (e.g., network administrator) of the determined network failures and enable the user to perform one or more actions to resolve the determined network failures.

In the exemplary embodiment, client devices 10 may be configured to generate streaming data including data representing states of network traffic. A state of network traffic to and/or from client device 10 may include, for example, a speed and/or type of data transmitted from and/or to client device 10. Additionally, the state of network traffic may include, for example, information indicating an error in the network system. For example, a router (as an example of client device 10) may detect that a device (which may also be an example of client device 10) connected to the router is not responding to a message within an expected time period. In such a case, the router may generate data indicating an error state of the non-responding device. Moreover, a state of network traffic to and/or from client device 10 may include a physical and/or logical location of client device 10. The state of the network traffic may vary over time. Accordingly, the streaming data may include data of changing states of the network traffic.

The streaming data generated by client devices 10 may be pre-processed for further processing by central processing device 30. For example, state data relating to one or more of client devices 10 (client objects in this exemplary embodiment) may be derived from the streaming data. The state data may include, with regards to each of the one or more of the client devices 10, a combination of identification information of client device 10 and information indicating a state of the network traffic to and/or from client device 10. The state data may be in a format that can be understood (e.g. parsed, interpreted, etc.) by central processing device 30. In some examples, the pre-processing of the streaming data to obtain the state data can be performed by client devices 10 in accordance with the software application provided by backend system 20. Additionally, the pre-processing of the streaming data may be performed by backend system 20.

The state data derived from the streaming data may be sent to central processing device 30. The central processing device 30 may be configured to process the state data derived from the streaming data generated by client devices 10. For example, central processing device 30 may process the state data to visualize the states of client objects (client devices 10 in this exemplary embodiment) in real time. The visualized states of the client objects may be provided to a user of central processing device 30 using virtual reality (VR) system 50 connected to central processing device 30 via an interface (not shown) for VR system 50, for example. The VR system 50 may be a known system that can provide a VR environment to a user.

The AI engine 40 may be configured to provide a user of the central processing device 30 with information suggesting an action to be taken by the user based on the state data received by central processing device 30. For example, AI engine 40 may be in communication with central processing device 30 and backend system 20 and suggest an action from among available actions to be taken by the user in accordance with backend system 20, based on the state data received by central processing device 30. The AI engine 40 may learn which action to suggest to the user, based on one or more inputs from the user received in response to the suggestion made by AI engine 40.

It should be noted that FIG. 1 shows a mere example of a network system and the configuration of the network system is not limited to that shown in FIG. 1. For instance, the network system may comprise more than one central processing devices 30. Different processing devices 30 may be deployed in different locations. When the network system comprises multiple central processing devices 30, backend system 20 may be configured to synchronize the state data received from multiple central processing devices 30, so that all of central processing devices 30 can have the same real time view on the actual states of client objects.

According to one preferred embodiment, synchronization of the state data may be performed or executed by using the network protocol, for example, a Message Queueing Telemetry Transport (MQTT) protocol. MQTT is not client-server protocol, but rather a broker-subscriber model. When a message is published, e.g., for a certain queue, each corresponding subscriber of the queue may receive the message. The subscriber will receive the message as long as the subscriber has subscribed to the corresponding queue. This also includes offline time of individual subscribers, when configured so. In an embodiment, synchronization may mean that each subscriber will, at some point, receive each message, when configured so. In yet another aspect, synchronization may also mean that each subscriber, when connected, will receive the message at the approximately same time. According to a preferred embodiment, backend system 20 does the pre-processing and the synchronization, e.g., by using MQTT protocol. The pre-processing happens before sending out the processed message to each client. Advantageously thereby compute time is saved, since each processing is only done once.

Further, although backend system 20, central processing device 30 and AI engine 40 are shown as separate elements in FIG. 1, in some examples, at least two of these elements may be integrated into a single system.

Functional Configurations for Real Time Data Processing

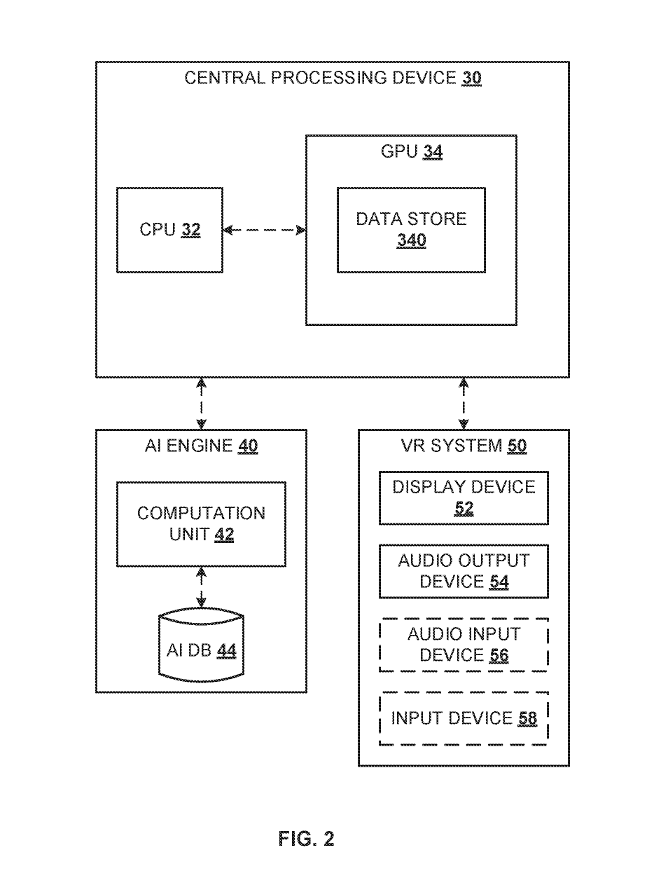

FIG. 2 shows a block diagram of central processing device 30, AI engine 40 and VR system 50. As shown in FIG. 2, central processing device 30 may comprise a central processing unit (CPU) 32 and graphics processing unit (GPU) 34. The CPU 32 may be configured to receive state data derived from streaming data generated at client devices 10. The state data may relate to one or more of the client objects (which may be client devices 10 in this exemplary embodiment). In an exemplary embodiment, the state data of each client device 10 may be a state relating to network traffic to and/or from client device 10.

The CPU 32 may be further configured to forward to GPU 34, the received state data as update information relating to the one or more of the client objects. In some examples, CPU 32 may forward the received state data as the update information to GPU 34 in a predetermined time interval (e.g., 10 milliseconds (ms)). The time may be derived from the aspired frame rate. As an example, for obtaining 100 frames per second (fps), an interval less or equal to 10 ms would be required. Frame rates of 60 fps may be obtained thus providing user-friendly result, similar to conventional graphics applications, such as video games. Further, even higher framerates may be obtained, i.e. greater than 60 fps, e.g. 100 fps, thereby resulting in user friendly display in virtual reality devices. Further, the range may be from 60 fps (e.g., 16.6 ms) up to “unlimited fps” (e.g., close to 0 ms).

In an embodiment, CPU 32 may simply forward to GPU 34, all the state data received during the predetermined time interval as the update information. Alternatively, the CPU 32 may include, in the update information to be forwarded to the GPU 34, for each of the one or more of the client objects, information indicating the state of the client object and having been received latest during the predetermined time interval. This may ensure that GPU 34 will receive the latest state arrived during the predetermined time interval at CPU 32 for each client object.

In an exemplary embodiment, the update information may include, with respect to each of the one or more of client devices 10, a combination of identification information of client device 10 and information indicating a state of the network traffic to and/or from client device 10.

The GPU 34 may be a processor configured to perform processing concerning graphic images. The GPU 34 may comprise a plurality of processors (e.g. cores) that can perform parallel processing. The GPU 34 may further comprise data store 340 for storing one or more attributes of each client object (each client device 10 in this exemplary embodiment). For example, each client object may be allocated a storage area within data store 340 for storing the attributes of the client object. Further, GPU 34 may access the storage areas allocated for a plurality of client objects in parallel, e.g. with the plurality of processors. The attributes may be information that are necessary for performing rendering to display, on a display device, image objects corresponding to the client objects. The data store 340 of the GPU 34 may further store a state of each client object. For example, in a similar manner for the attributes, each client object may be allocated a storage area within data store 340 for storing the state of the client object and GPU 34 may access the storage areas for a plurality of client objects in parallel with the plurality of processors. In this exemplary embodiment, data store 340 may store, for each client device 10, a state relating to network traffic to and/or from client device 10.

The GPU 34 may be configured to receive the update information from the CPU 32. Further, GPU 34 may update the attributes in the data store 340, using the received update information, for each of the one or more of the client objects to which update information relates. For example, GPU 34 may calculate the attributes for each client object according to the state of the client object included in the update information. The GPU 34 may perform the update in parallel for each client object since GPU 34 may access the storage areas within data store 340 allocated for attributes of a plurality of client objects as stated above.

The GPU 34 may be further configured to perform, for each client object, rendering using the attributes of the client object stored in the data store 340 to display, on a display device, a plurality of image objects corresponding to the client objects. The display device may be a display device comprised in the VR system 50. The GPU 34 may perform the rendering in parallel for each client object since, as stated above, the GPU 34 may access the storage areas within the data store 340 allocated for attributes of a plurality of client objects.

In some embodiments and/or examples, GPU 34 may perform the update of the attributes and the rendering for each client object every time GPU 34 receives the update information from CPU 32. Thus, in case CPU 32 forwards the update information to GPU 34 in a predetermined time period as stated above, GPU 34 may also perform the update and the rendering in the predetermined time period.

The VR system 50 may be implemented with a VR headset that is configured to provide a VR environment to a user. The VR system 50 may comprise display device 52 (e.g., a screen to be placed in front of the eyes when the VR headset is worn by a user), audio output device 54 (e.g., a speaker or a headphone, etc.) and audio input device 56 (e.g., microphone), for example. In addition to audio input device 56, VR system 50 may comprise input device 58 configured to receive one or more user inputs. For example, input device 58 may be configured to detect positions and/or movements of at least a part of the user's hand(s), which may be interpreted as the user input(s). Alternatively, for example, input device 58 may be a known controller device that is configured to receive one or more user inputs by detecting one or more buttons (e.g. switches) being pressed and/or the controller being moved by the user. In some examples, VR system 50 may further comprise a haptic device (not shown) that is configured to provide haptic feedback to a user.

The AI engine 40 may be configured to provide an interface to a user of central processing device 30 as to how to interact with the displayed data. The AI engine 40 may provide an interface for man-machine interaction with regards to the user of central processing device 30 and the network system. The AI engine 40 may comprise computation unit 42 and AI database (DB) 44.

The computation unit 42 may be configured to perform computation for AI engine 40 to provide information suggesting an action to be taken by the user based on the state data received by central processing device 30. For example, computation unit 42 of AI engine 40 may obtain the state data from CPU 32 and perform computation to determine a suggested action to be taken by the user. Additionally, computation unit 42 may obtain states of the client objects from GPU 34 in the examples where data store 340 of GPU 34 stores the states of the client objects. The computation unit 42 may perform the computation in accordance with a known machine learning technique such as artificial neural networks, support vector machine, etc. The suggestion determined by computation unit 42 may be sent from AI engine 40 to central processing device 30 via network 60 and may then be provided to the user by outputting the information representing the suggestion using display device 52 and/or audio output device 54 of VR system 50. Alternatively, AI engine 40 itself may be connected to VR system 50 and provide the information representing the suggestion directly to VR system 50. As will be described more in detail later below, the user may provide one or more inputs using the audio input device 56 and/or the input device 58 of the VR system in response to the suggestion by AI engine 40. Additionally, the user input(s) in response to the suggestion by AI engine 40, may be input via an input device (not shown) of central processing device 30, such as a mouse, keyboard, touch-panel, etc. The user input(s) to the VR system may be sent back to AI engine 40 directly or via central processing device 30 and the network 60. The user input(s) may further be forwarded to backend system 20. The computation unit 42 may further perform computation to learn which action to suggest to the user, based on the user input(s), in response to the suggestion by AI engine 40. The backend system 20 may also provide some feedback to AI engine 40 concerning the user input(s) and the AI engine 40 may use the feedback from the backend system 20 for the learning.

The AI DB 44 may store data that is necessary for the computation performed by computation unit 42. For example, AI DB 44 may store a list of possible actions to be taken by the user. The list of possible actions may be defined in accordance with the software application implemented by backend system 20. For example, in the exemplary embodiment of monitoring network traffic, the possible actions may include, but are not limited to, obtaining information of client device 10 with an error (e.g., no data flow, data speed slower than a threshold, etc.), changing software configuration of client device 10 with an error, repairing or replacing client device 10 with an error, etc. The AI computation unit 42 may determine the action to suggest to the user from the list stored in AI DB 44.

Further, AI DB 44 may store data for implementing the machine learning technique used by computation unit 42. For example, in case computation unit 42 uses an artificial neural network, AI DB 44 may store information that defines a data structure of the neural network, e.g., the number of layers included in the neural network, the number of nodes included in each layer of the neural network, connections between nodes, etc. Further, AI DB 44 may store values of the weights of connections between the nodes in the neural network. The computation unit 42 may use the data structure of the neural network and the values of the weights stored in AI DB 44 to perform computation for determining the suggested action, for example. Further, computation unit 42 may update the values of the weights stored in AI DB 44 when learning from the using the user input(s).

Real Time Data Visualization Processing

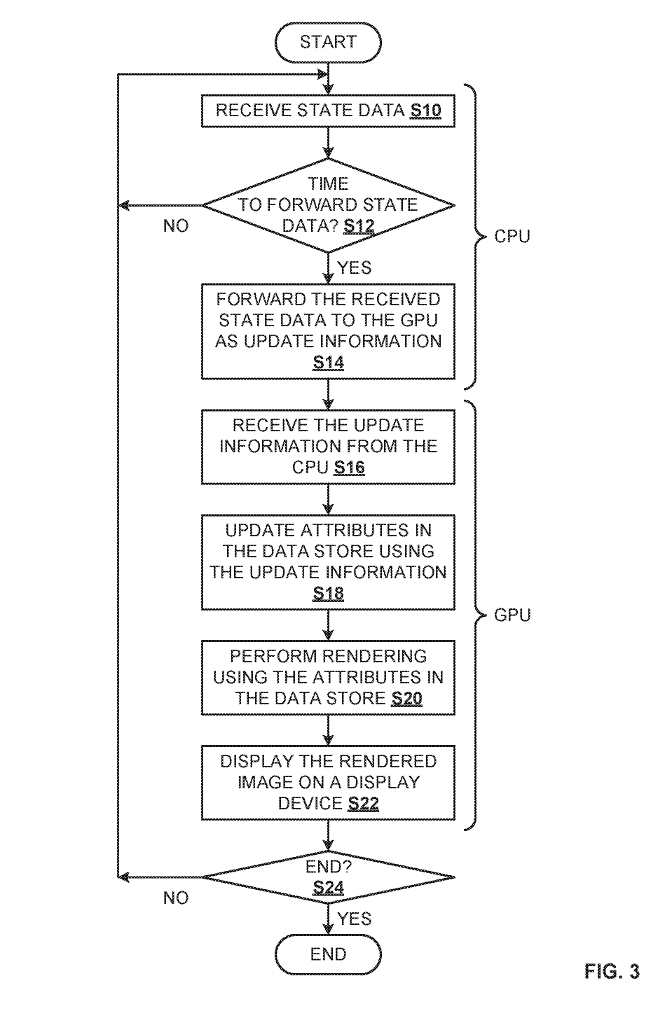

In the following, exemplary processing for visualizing incoming data in real time will be described with reference to FIG. 3. In the exemplary embodiments and various examples described herein, the state data relating to client objects may be visualized on a display device, e.g. in a virtual space provided by VR system 50. Image objects corresponding to the client objects may be animated. Thus, the image objects may move over time and/or change their visualization (e.g. appearance such as form, color, etc. and/or the ways they move, e.g. speed, direction of movement, etc.) over time. The movement and/or the change of visualization of the image objects may correspond to changes in states of the corresponding client objects. In addition, sound corresponding to the animation of the image objects may be generated and output via. e.g. audio output device 54 of VR system 50.

FIG. 3 shows a flowchart of an exemplary processing performed by central processing device 30 for visualizing an incoming data in real time. In FIG. 3, steps S10 to S14 and S24 may be performed by CPU 32 of central processing device 30 and steps S16 to S22 may be performed by GPU 34 of central processing device 30. The exemplary processing shown in FIG. 3 may be started in response to an input by a user of central processing device 30, instructing display of data, for example. In step S10, CPU 32 may receive state data derived from streaming data generated at client devices 10. The state data may relate to one or more of the client objects. In the exemplary embodiment of monitoring network traffic, the client objects may be the client devices and the state data of each client device 10 may be a state relating to network traffic to and/or from the client device 10. The processing may proceed to step S12 after step S10.

In step S12, CPU 32 may determine whether or not the time to forward the received state data to GPU 34 has come. For example, in case CPU 32 is configured to forward the state data in a predetermined time interval, the CPU 32 may determine whether or not the predetermined time interval has passed since CPU 32 forwarded the state data for the last time. If the predetermined time interval has passed, CPU 32 may determine that it is time to forward the received state data. If the predetermined time interval has not yet passed, CPU 32 may determine that it is not yet time to forward the received state data. When the CPU 32 determines that the time to forward the received state data has come (Yes in step S12), the processing may proceed to step S14. Otherwise (No in step S12), processing may return to step S10.

In step S14, the CPU 32 may forward the received state data to GPU 34 as update information relating to the one or more of the client objects. In some examples, CPU 32 may forward to GPU 34, all the state data received during the predetermined time interval as the update information. In other examples, CPU 32 may include, in the update information to be forwarded to GPU 34, for each of the one or more of the client objects, information indicating the state of the client object and having been received latest during the predetermined time interval. In an embodiment, for each client object, the latest state arrived at the CPU 32 during the predetermined time interval may be forwarded to GPU 34.

In step S16, GPU 34 may receive, from CPU 32, the update information relating to the one or more of the client objects. In the exemplary embodiment of monitoring network traffic, the update information may include, with respect to each of the one or more of client devices 10, a combination of identification information of client device 10 and information indicating a state of the network traffic to and/or from client device 10.

In step S18, GPU 34 may update attributes in data store 340 using the received update information, for each of the one or more of the plurality of client objects to which the update information relates. For example, GPU 34 may calculate the attributes for each client object according to the state of the client object included in the update information. Since the update information includes information indicating a state of each of the one or more of the client objects, the calculated attributes of each client object may reflect the state of the client object. The calculated attributes may be (over)written in the storage area within data store 340, allocated for the corresponding client object. The update may be performed in parallel for each client object since GPU 34 may access the storage areas within the data store 340 allocated for attributes of a plurality of client objects as stated above.

In some examples, the calculation of the attributes to update the attributes in step S18 may be performed using a compute shader, which is a computer program that runs on GPU 34 and that makes use of the parallel processing capability of GPU 34. The compute shader may be implemented using a known library for graphics processing, such as Microsoft DirectX or Open Graphics Library (OpenGL).

For updating the attributes in step S18, the compute shader may assign a state of a client object included in the received update information, to a storage area within data store 340. For example, in case GPU 34 has received a state of a particular client object for the first time (e.g. no storage area has been allocated yet for the particular client object), the compute shader may assign the particular client object to a new storage area within data store 340. On the other hand, for example, in case GPU 34 has received a state of a particular client object for the second or subsequent time (e.g. a storage area has already been allocated for the particular client object), the compute shader may identify the storage area within data store 340 for the particular client object using, e.g. the identification information of the particular client object included in the update information. The compute shader may store states of the client objects in the corresponding storage areas within data store 340. Further, the compute shader may allocate a storage area within data store 340 for storing attributes of each client object in a manner analogous to that for the state of each client object as stated above.

The compute shader may then calculate updated attributes for each of the client objects which the received update information relates to. The attributes of each client object may be based on the state of the client object. The attributes of each client object may be information necessary for rendering and may include, for example, position, color, size, distortion and/or texture of a corresponding image object to be displayed. The position included in the attributes may be considered as a “zero-point” (e.g., origin) of the image object, for example in the VR space. The positions of the image objects may be determined based on the similarity of the states of the corresponding client objects. For example, image objects corresponding to client objects with states that are considered to be similar may be arranged close to each other. The similarity of the states of two client objects may be determined by, for example, the distances between the physical and/or logical locations of the two client objects (e.g. client devices 10). The attributes may further include sound to be output in accordance to the state of the client object.

Moreover, in some examples, the compute shader may calculate, for each client object, a (virtual) distance between a position of the corresponding image object and a position of the user's hand(s) and/or a controller device (as an example of input device 58) in VR system 50. The position of user's hand(s) is merely exemplary and other gestures like body movement, like body position or turning the head, etc., may be applicable. The calculation of the distance may be used for detecting user interaction of “grabbing” and/or “picking up” of the image object in the VR environment provided by VR system 50. Here, “grabbing” and/or “picking up” of the image object may be understood to be overriding the position of the image object with the position of the user's hand(s) and/or the controller device (e.g. the input device 58 of the VR system 50). The calculated distance may also be stored in the data store 340 as a part of the attributes. According to an embodiment, the calculation happens every frame, so this information would be obsolete quickly and needs not be stored.

After step S18, the processing may proceed to step S20.

In step S20. GPU 34 may perform, for each client object, rendering using the attributes of the client object stored in data store 340 to display, on a display device, a plurality of image objects corresponding to the client objects. The GPU 34 may perform the rendering in parallel for each client object since GPU 34 may access the storage areas within the data store 340 allocated for attributes of a plurality of client objects.

In some examples, the plurality of image objects to be displayed may be 3-dimensional (3D) image objects. Each 3D image object may comprise a plurality of polygons. The GPU 34 may have access to a description and/or a list of all relative offsets for each polygon. The description and/or list may be stored in data store 340 or another storage device accessible by GPU 34. The description and/or list may be common for all the 3D image objects to be displayed, since the base form may be the same for all the 3D image objects. In the rendering step of S20, GPU 34 may obtain the “zero-point” of each image object from the attributes stored in the data store 340 and calculate, based on each “zero-point”, relative positions of the polygons of the corresponding 3D image object using the description and/or list of all relative offsets for each polygon. 3D image objects with different sizes may be rendered by applying multiplication operation to the relative offsets, in accordance with the size of each image object indicated in its attributes stored in data store 340. Further, according to other attributes such as color, animation, sound, distortion and/or texture of the image objects stored in the data store 340, GPU 34 may determine the final position, orientation, color, etc. of each polygon comprised in the image objects.

In some examples, the rendering in step S20 may be performed using a vertex shader and a fragment shader which are computer programs that run on GPU 34. The vertex shader may perform processing for each individual vertex of each polygon comprised in each 3D image object. For example, the vertex shader may determine a specific position of the individual vertex on the display device using the attributes of each 3D image object as stated above. It is noted that the attributes of each 3D image object calculated and stored in the data store 340 may be structured in a manner such that the vertex shader may obtain only information that is necessary for the rendering. The fragment shader may perform processing for each pixel of an overall image including the 3D image objects to be displayed. The fragment shader may take the output of the vertex shader as an input and determine, for example, a color and a depth value of each pixel. In an embodiment, the vertex shader and the fragment shader may also be implemented using a known library for graphics processing, such as Microsoft DirectX or OpenGL.

Each vertex is derived from the “common list of vertices”, that all objects share. Hence, for all vertices of one object, only one set of attributes is necessary.

Further, in step S20, for client objects with attributes indicating sound to be output, CPU 32 may also generate instructions to output the sound in accordance with the attributes. The instructions may be provided to the VR system 50.

Specifically, sound may be played when updates are sent to GPU 34. If the time to update has come, a sound is played. This is possible because, advantageously CPU 32 is not under heavy load as GPU 34 is doing all computations for the visualization. Sound may be played in accordance to the pre-processed state, CPU 32 receives. The sound that has to be played can be determined from the state without further processing. As an example, if the state=1, play sound 1. If state=2, play sound 2. This may be done for each object's state. In other words, sound may be played in accordance with the state, not the attributes.

According to another embodiment, GPU 34 the above, i.e. providing and playing sound, may be carried out by GPU 34.

After the rendering in step S20, the processing may proceed to step S22.

In step S22, the GPU 34 may display the rendered image on a display device, for example, on display device 52 of the VR system 50. For example, GPU 34 may provide the display device 52 of VR system 50 with the data of the rendered image. Further, in case instructions for outputting sound are generated in step S20, CPU 32 (or, according to another embodiment the GPU 34) may provide VR system 50 with the instructions for outputting the sound. The audio output device 54 of VR system 50 may output sound according to the instructions.

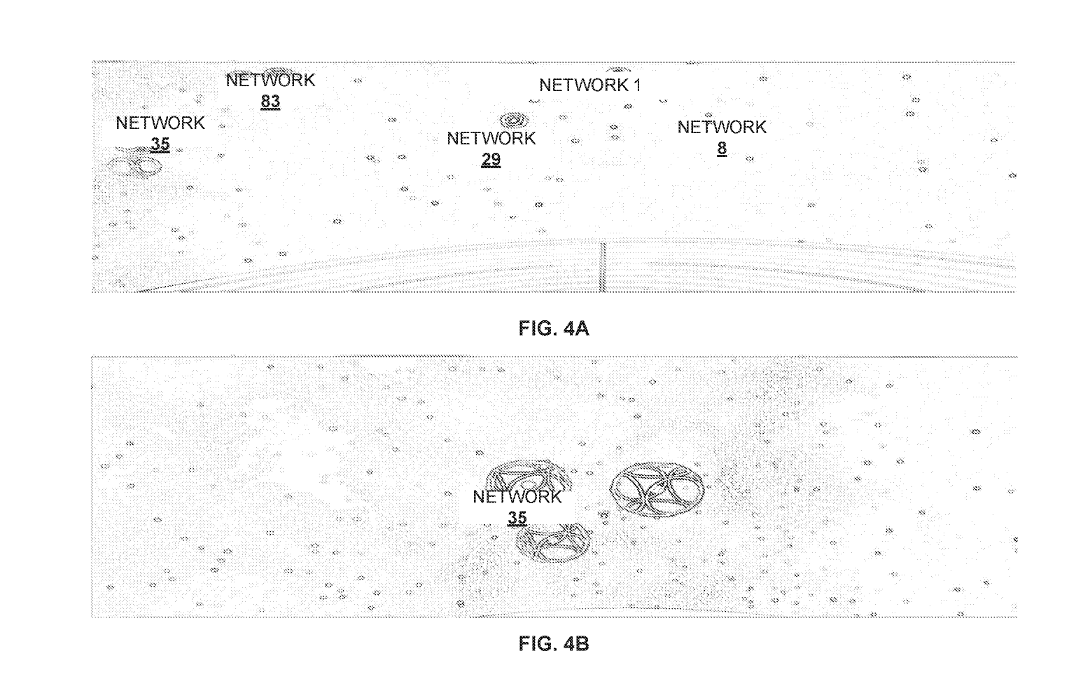

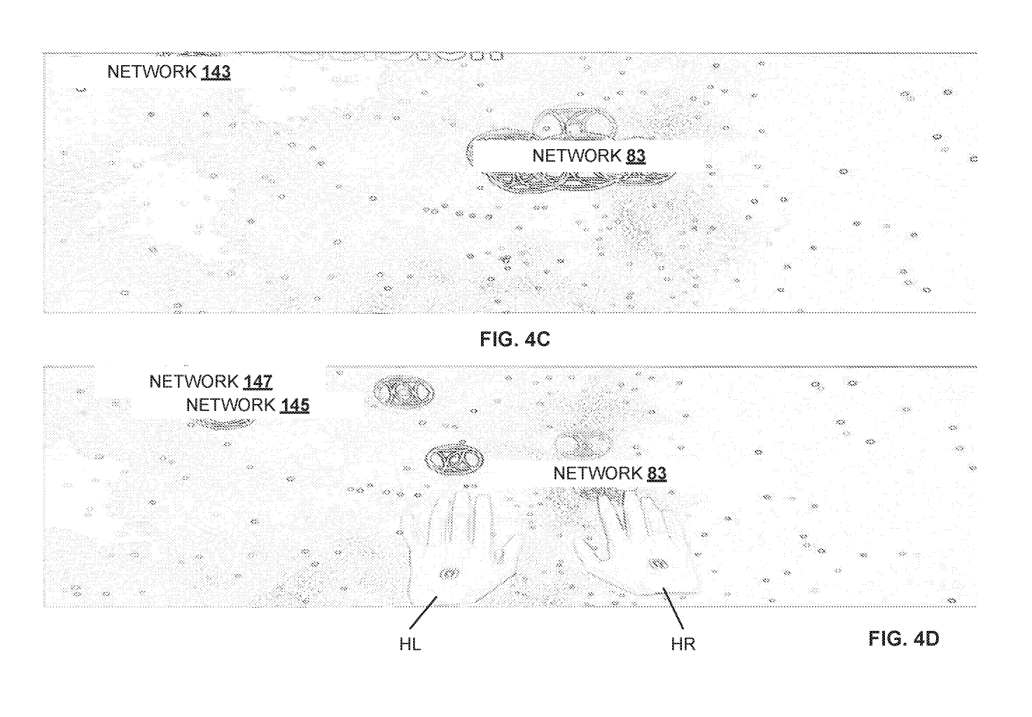

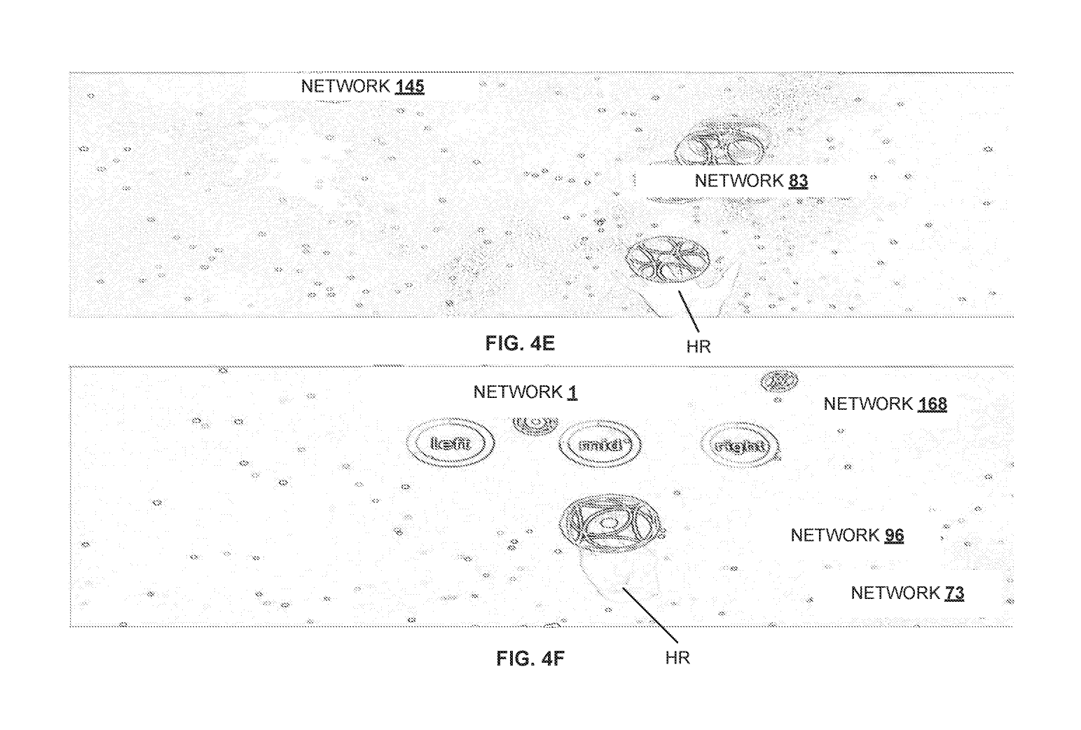

FIGS. 4A to 4F show exemplary images that may be displayed on display device 52 of VR system 50 by central processing device 30 in step S22. Spheres shown in FIGS. 4A to 4F are exemplary image objects corresponding to the client objects (e.g. client devices 10 in the exemplary embodiment for network traffic monitoring). The elements “Network 1”, “Network 8”, “Network 29”, “Network 35”, “Network 83”, etc. shown in FIGS. 4A to 4F may correspond to physical and/or logical locations of client devices 10 included in the network system that is being monitored. The elements in FIGS. 4A to 4F may correspond to parts of the network system that is being monitored. For example, each of these elements in FIGS. 4A to 4F may correspond to a part of the network which is under control of a particular router. Additionally, each of these elements may correspond to a part of the network which is installed in a particular building (or a particular room of a particular building), for example. Further, some of these elements shown in FIGS. 4A to 4F may correspond to parts of the network which may be accessed by certain groups of users (e.g., users belonging to particular organizations such as companies, research institutes, universities, etc.). Accordingly, the spheres shown close to and/or overlapping with one of these elements in FIGS. 4A to 4F may indicate that the corresponding client devices 10 belong to the corresponding parts of the network system. Further, the appearance (e.g, color, texture, size, etc.) and/or movement of each image object may represent the state of the corresponding client device 10, e.g. the state of the network traffic to and/from the corresponding client device 10. For instance, when a network failure occurs with respect to client device 10, the image object corresponding to client device 10 may be shown in a certain color (e.g., red) and/or in a certain manner (e.g., blinking).

After step S22, the processing may proceed to step S24.

In step S24, CPU 32 may determine whether or not to end the processing shown in FIG. 3. For example, if the user of central processing device 30 inputs, via audio input device 56 or the input device 58 of VR system 50 or another input device not shown, an instruction to end the processing. CPU 32 may determine to end the processing and the processing may end (Yes in step S24). In case CPU 32 may determine not to end the processing (No in step S24), the processing may return to step S10.

According to the exemplary processing described above with reference to FIG. 3, the attributes of each client object may be (re)calculated for each frame before rendering (see e.g., step S18). Thus, changes in states of client objects may be reflected in each rendered frame.

Further, according to the exemplary processing described above with reference to FIG. 3, in particular by the rendering step S20 using the description and/or list of all relative offsets for each polygon and the “zero-point” of each image object, computational resources required for the rendering may be reduced. For example, assume that each 3D image object has 3000 polygons and 10000 instances of these objects are to be rendered. If data of the 3000 polygons for each instance are maintained, data of 30 million polygons needs to be maintained. However, with a hierarchical approach using a common description and/or list of all relative offsets for each polygon as stated above, the amount of data to be maintained can be reduced to data of one array (or list) describing the 3D image object with 3000 polygons and a list of 3D image objects with parameters (e.g. 10000 image objects with, for example, 12 attributes which may result in 3 of 4-component-vectors each). Thus, in this exemplary case, instead of 30 million vectors of data, data of 33000 vectors, for instance.

The hierarchical approach as stated above may fit to the general GPU architecture. The use of a common description of relative offsets for each polygon for the same or similar objects may be applied in a known rendering processing, for e.g. rendering grass or hair. However, grass or hair may be considered “imprecise”, since, for example, the angle of a hair may not be deeply meaningful. In contrast, in the exemplary embodiments and various examples described herein, the calculations for rendering each image object can be more meaningful, as the client objects corresponding to the image objects may have individual meaning and/or significance. For example, each image object may correspond to client device 10 in the network system that is being monitored and the state of client device 10 represented by the appearance and/or movement of the image object may correspond to the network traffic to and/or from client device 10. Further, in a known rendering system, e.g. in a video game, calculations for rendering objects with individual meaning and/or significance (e.g. player models) are usually performed by the CPU, since there are usually not comparable amounts of “meaningful” objects. In contrast, in the exemplary embodiments and various examples described herein, the calculations for rendering are performed by GPU 34.

Accordingly, the exemplary processing, as described above with reference to FIG. 3, may achieve a high framerate that is high enough to receive a stutter-free output. Further, GPU 34 effort may be maximized, for example, to around 100 frames per second, up to 15000 objects with 3000 polygons each, 4.5 billion animated/moving polygons per second. Such a result may not be obtained with CPU-controlled calculations. Further, render effects may be calculated based on the partially computer-generated geometry (e.g. vertices).

User Interaction and AI

The network system and the processing of visualization, as stated above with reference to FIGS. 1 to 3, state data of the client objects may be rendered into a VR environment. Thus, a plurality of events that may trigger change of states of the client objects may be displayed in the VR environment. The user of the central processing device 30 can obtain a different view and understanding on the overall displayed data leveraging the user's spatial comprehension. Through VR system 50 and the central processing device 30, the user may interact with the system and manipulate the data in real time.

For interaction with the system, the user may use audio input device 56 and/or the input device 58 of VR system 50. In case of using audio input device 56, the user may speak to the audio input device 56 and the user speech may be interpreted by the VR system 50. In this case, VR system 50 may comprise a speech recognition system for interpreting the speech of the user.

Further, for example, the user may use input device 58 of VR system 50 to select one or more image objects for obtaining data relating to the corresponding client objects. For instance, the user may activate or select a client object by “grabbing” or “picking up” an image object by his/her hand in the VR environment, which may be detected by the input device 58 of VR system 50 (see e.g., FIGS. 4E and 4F, the user's virtual right hand HR is “grabbing” or “picking up” a sphere, an exemplary image object). Alternatively, for example, in case the input device 58 is a controller device, the user may touch and/or point to an image object with the controller device. In response to the activation/selection of an image object by the user, central processing device 30 may display the state data of the corresponding client object stored in data store 340 of the GPU and/or data relating to the corresponding client object in a database of backend system 20. Activation/selection of an image object by the user would be reflected in backend system 20; in backend system 20 the selection/activation would be registered accordingly.

To facilitate user interaction, AI engine 40 may, in parallel to the display of the image objects by the central processing device 30 as described above, provide information for steering and/or guiding the user of next possible interactions in the VR environment, via display device 52 and/or audio output device 54 of VR system 50. For example, AI engine 40 may provide audio speech with the audio output device 54 of the VR system 50 to, e.g., inform the user what to focus on, ask the user how to deal with the displayed data, guide the user to next tasks, etc. The AI engine 40 may learn based on the user's interactions and/or decisions. In addition, AI engine 40 may provide the information to the user via display device 52 of the VR system in a natural language text.

The suggestions provided for the user may relate to tasks defined by the software application of backend system 20 (e.g., monitoring and/or managing network traffic, resolving network failure, etc.). With the user's interactions and/or decision. AI engine 40 may be trained on future interactions and/or decisions on how to perform on similar processes and/or patterns in the future. As the learning proceeds, human interactions for repetitive tasks may be reduced and the tasks may be automated by AI engine 40.

The AI engine 40 does not necessarily be trained before use with central processing device 30. In some examples, at the time of starting using AI engine 40, AI DB 44 may include no learning result to be used for making suggestions to the user according to the machine learning technique employed by the AI engine 40. In other words, AI DB 44 may be “blank” with respect to the learning result. In such a case, at the time of starting using AI engine 40, AI DB 44 may merely include a list of possible actions to be taken and initial information concerning the machine learning technique employed. For example, in case AI engine 40 uses an artificial neural network, AI DB 44 may include the data structure of the artificial network and initial values of weights of connections between nodes of the artificial neural network.

When no (or little) learning result is stored in AI DB 44, AI engine 40 may not be able to determine an action to be suggested to the user. In case AI engine 40 fails to determine an action to be suggested to the user, AI engine 40 may output, using audio output device 54 and/or display device 52 of VR system 50, information to ask the user to make a decision without the suggestion from AI engine 40 and then monitor user inputs to the VR system 50 in response to the output of such information. Thus, AI engine 40 may ask for a decision by the user every time a new situation (e.g. combination of state data) comes up. The decision provided by the user is provided as input to the AI database. Alternatively, AI engine 40 may monitor user inputs to VR system 50 without outputting any information. The AI engine 40 may learn (in other words, train the AI) according to the machine learning technique employed, using the state data obtained from the central processing device 30 and the monitored user inputs to VR system 50. Accordingly, AI engine 40 may be trained by the user for so-far-undefined action(s) (e.g. solution(s)) for a task and, when the same or similar situation occurs for the next time, AI engine 40 may automatically perform the learnt action(s) for the task. Here, the same learnt actions may be taken not only for the same situation and/or task but also for a similar situation and/or task. The granularity of “similar” situation and/or task can be defined according to the needs of the software application implemented by backend system 20.

Variations

The exemplary embodiment and examples as stated above relate to monitoring network traffic of the network system. However, other exemplary embodiments and examples may relate to different applications.

For example, a client object may be a user of at least one of client devices 10 and central processing device 30 may process data relating to one or more activities performed by the user using the at least one of the client devices. In this respect, backend system 20 may implement a software application for managing data relating to users of the client devices 10 and/or providing one or more services to users of client devices 10. Examples of such a software application may include, but are not limited to, SAP Hybris Marketing, SAP Hybris Loyalty. SAP Hybris Profile, SAP Hybris Commerce and any other connected SAP/SAP Hybris tools, or external third-party application programming interfaces (APIs).

For specific example, assume that client objects are users (e.g. customers) of an online shopping website and/or a physical shop. In case of customers of an online shopping website, the customers may access the online shopping website using client devices 10. In case of customers of a physical shop, each customer of a physical shop may carry a mobile device (which may be an example of client device 10) in the shop and the mobile device may generate streaming data concerning the customer's activities in the shop. In either case, the customer may enter his/her user ID or input using any other authentication technique on the client device 10 and the user ID may be included in the state data to be received by the central processing device 30.

In this specific example, the state data of a client object may indicate activities of the corresponding customer. In case of a customer of an online shopping website, activities of the customer may include, but are not limited to, browsing or exploring the website, searching for a certain kind of products, looking at information of a specific product, placing a product in a shopping cart, making payment, etc. The information indicating such activities on the website may be collected from, for example, the server providing the website and/or the browser of client device 10 with which the customer accesses the website.

In case of a customer of a physical shop, the activities of the customer may include, but are not limited to, moving within the physical shop, (physically) putting a product in a shopping cart, requiring information concerning a product, talking to a shop clerk, etc. The information indicating such activities may be collected by client device 10 (e.g. mobile device) carried by the customer. For example, client device 10 may be configured to detect the location and/or movement of the customer with a GPS (Global Positioning System) function. Further, for example, a label with computer-readable code (e.g. bar code, QR code, etc.) indicating information of a product and/or an RFID tag containing information of the product may be attached to each product in the physical shop and client device 10 may be configured to read the computer-readable code and/or the information contained in the RFID tag. The customer may let client device 10 read the computer-readable code and/or the information contained in the RFID tag and input to client device 10 information indicating his/her activity regarding the product (e.g., putting the product in a shopping cart, requiring information, ordering the product, etc.). The client device 10 may then generate data indicating the activity of the customer specified by the product information and the user input indicating the activity. Further, for example, when the customer talks to a shop clerk, the shop clerk may input his/her ID to client device 10 carried by the customer and client device 10 may generate data indicating that the customer is talking to the shop clerk for processing and enabling further customer engagement and commerce actions.

In this specific example, each image object displayed on display device 52 of VR system 50 may correspond to a customer. Further, the position of the image object to be displayed may correspond to, for example, the type of activity the user is performing on the website.

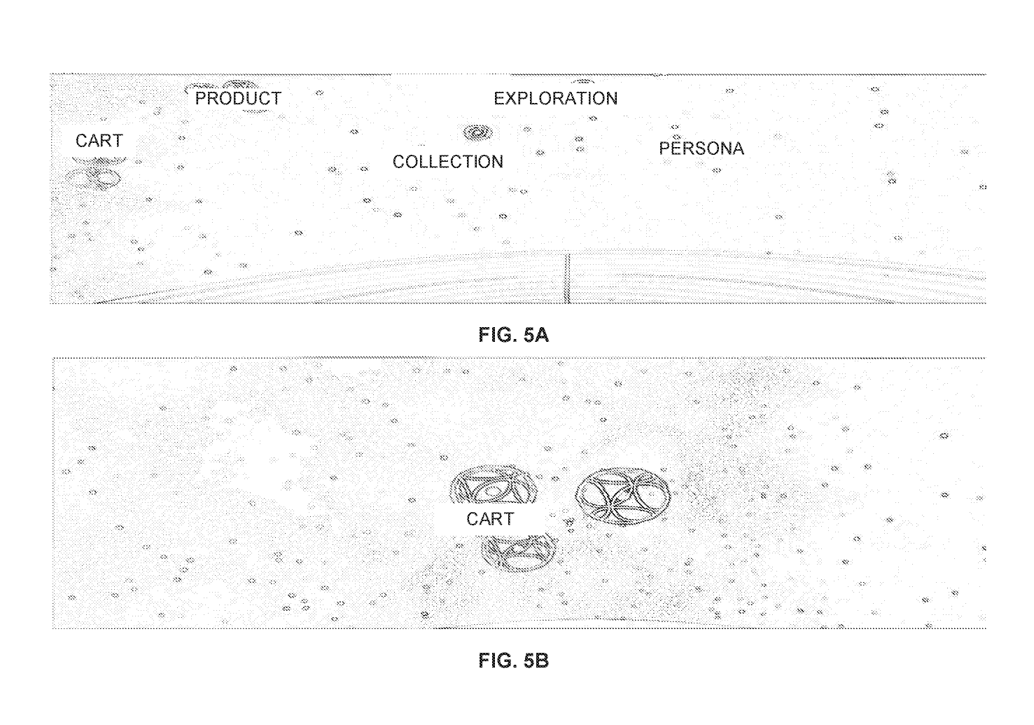

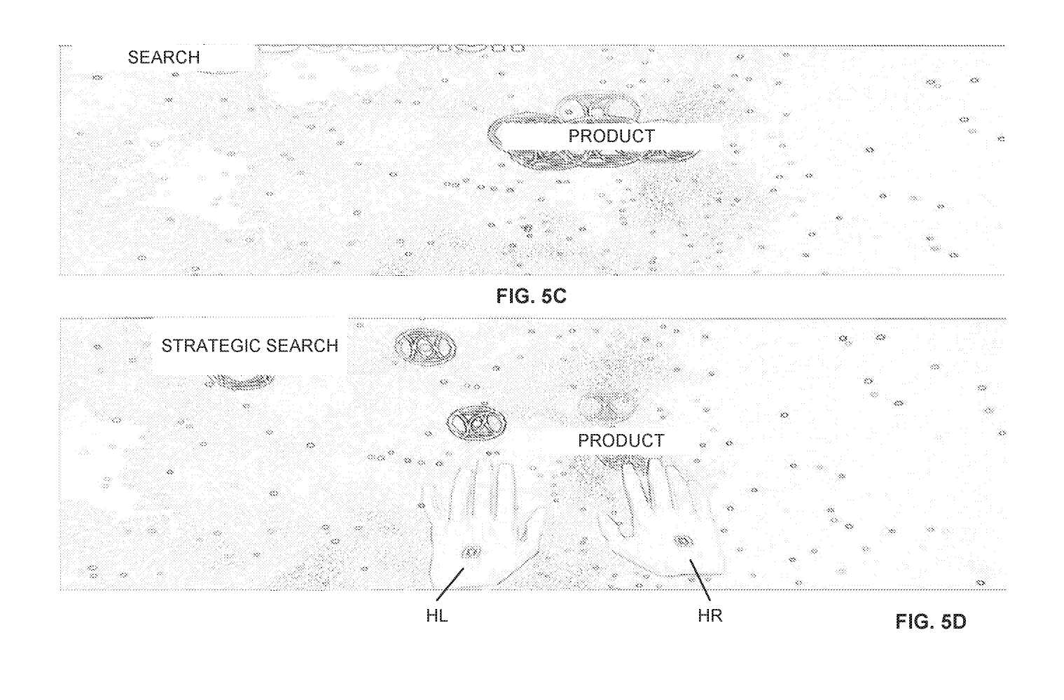

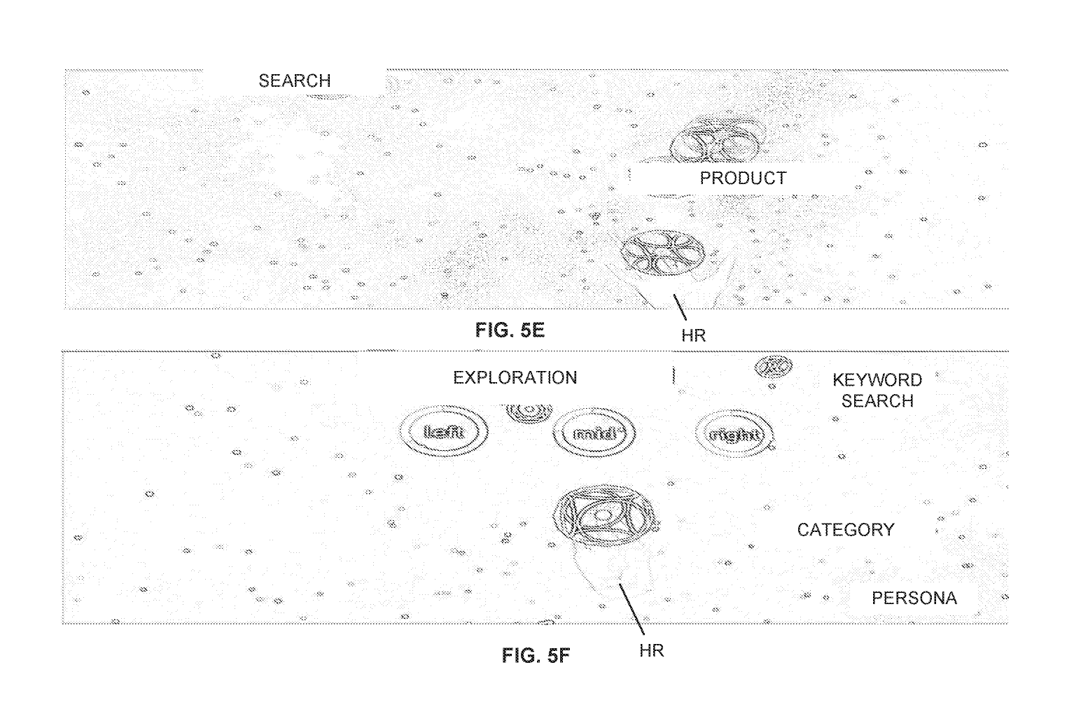

FIGS. 5A to 5F exemplary images that are displayed on a display device 52 of VR system 50 by central processing device 30 in this specific example. Spheres shown in FIGS. 5A to 5F are exemplary image objects corresponding to the customers. Terms such as “Exploration”, “Cart”, “Product”, “Search”, “Category”, “Persona”, “Keyword Search”, shown in FIGS. 5A to 5F correspond to the types of activities the customers may perform on the website. For example, spheres shown close to and/or overlapping with one of those terms may indicate that the customers corresponding to the spheres are currently performing the activity indicated by the term (see e.g., spheres shown close to or overlapping with the term “Cart” in FIG. 5B, with the term “Product” in FIGS. 5C and 5E).

In this specific example, AI engine 40 may suggest the user of central processing device 30 to provide assistance to the customers of the online shopping website. For instance, when a customer is looking at the same product or same kinds of products for longer than a predetermined threshold of time but not placing any product in the shopping cart, the customer may have a problem and/or need assistance in determining the product. In such a situation, AI engine 40 may suggest the user of the central processing device 30 to contact the customer of the website via, e.g., on-line chat system to provide any assistance the customer may need.

As stated above, the user of central processing device 30 may interact with the displayed data using VR system 50. Also, in this specific example, as can be seen in FIGS. 5D to 5F, the user of central processing device 30 may use his/her hand(s) to virtually “grab” or “pick up” a sphere in the image (see virtual hands HL, HR in FIGS. 5D to 5F). The central processing device 30 and/or AI engine 40 may show information concerning the customer corresponding to the sphere which is “picked up” by the user of central processing device 30 on the display (see e.g., FIG. 5F, information relating to the corresponding customer may be shown in places where the terms, “left”, “mid” and “right”, placed in circles). The information concerning the customer may be obtained from, for example, a database of backend system 20 that may maintain and manage profiles of customers (e.g., with SAP Hybris Profile).

Further, although the exemplary embodiments and examples described herein use VR system 50 for displaying data and providing interface for user interaction, the display of data and user interaction may be performed using a computer and a display device that do not use VR technique. For example, devices such as a personal computer, a tablet computer, a smartphone, etc. may be used for displaying data and providing interface for user interaction.

Hardware Configuration

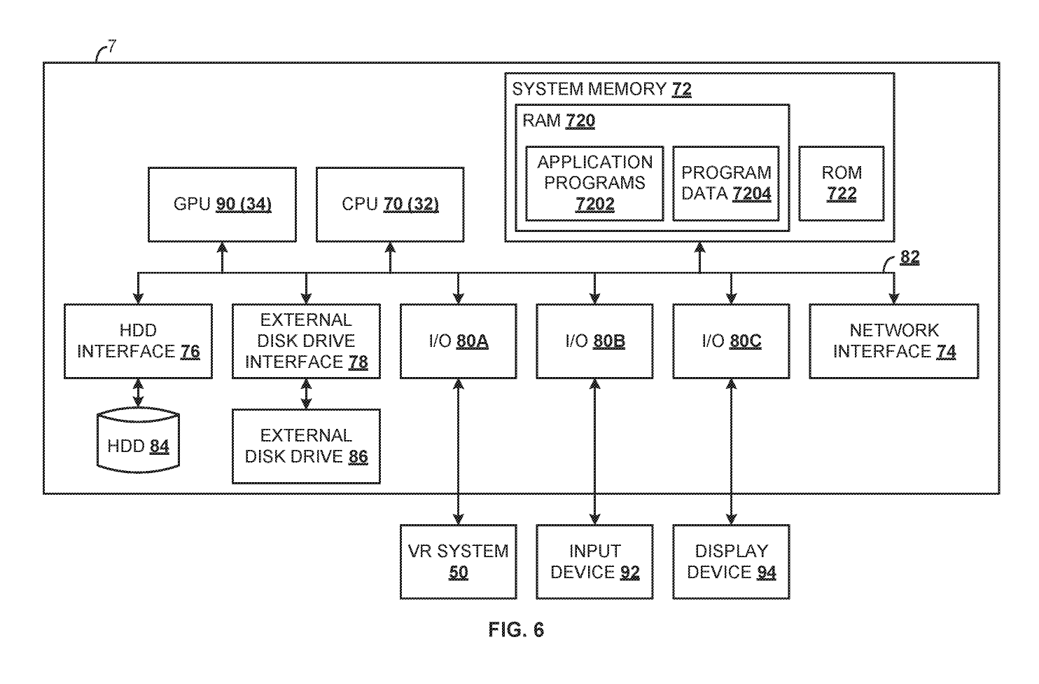

FIG. 6 shows an exemplary hardware configuration of a computer that may be used to implement client device 10, backend system 20, central processing device 30 and/or AI engine 40. The computer 7 shown in FIG. 6 includes CPU 70 (32), GPU 90 (34), system memory 72, network interface 74, hard disk drive (HDD) interface 76, external disk drive interface 78 and input/output (IO) interfaces 80. These components of the computer are coupled to each other via system bus 82. The CPU 70 may perform arithmetic, logic and/or control operations by accessing system memory 72. The CPU 70 may implement the processors of the exemplary devices and/or system described above. The GPU 90 may perform operations for processing graphics. In case computer 7 is used for implementing the exemplary central processing device 30, the GPU 90 may be GPU 34 of the exemplary central processing device 30 as described above. The computer 7 does not necessarily include GPU 90, for example, in case computer 7 is used for implementing a device other than the central processing device 30. The system memory 72 may store information and/or instructions for use in combination with the CPU 70. The system memory 72 may include volatile and non-volatile memory, such as random access memory (RAM) 720 and read only memory (ROM) 722. A basic input/output system (BIOS) containing the basic routines that helps to transfer information between elements within the computer 7, such as during start-up, may be stored in ROM 722. The system bus 82 may be any of several types of bus structures including a memory bus or memory controller, a peripheral bus, and a local bus using any of a variety of bus architectures.

The computer may include network interface 74 for communicating with other computers and/or devices via a network.

Further, the computer may include hard disk drive (HDD) 84 for reading from and writing to a hard disk (not shown), and external disk drive 86 for reading from or writing to a removable disk (not shown). The removable disk may be a magnetic disk for a magnetic disk drive or an optical disk such as a CD ROM for an optical disk drive. The HDD 84 and external disk drive 86 are connected to the system bus 82 by HDD interface 76 and external disk drive interface 78, respectively. The drives and their associated computer-readable media provide non-volatile storage of computer-readable instructions, data structures, program modules and other data for the general purpose computer. The data structures may include relevant data for the implementation of the method for encrypting and/or decrypting a document, as described herein. The relevant data may be organized in a database, for example a relational or object database.

Although the exemplary environment described herein employs a hard disk (not shown) and an external disk (not shown), it should be appreciated by those skilled in the art that other types of computer readable media which can store data that is accessible by a computer, such as magnetic cassettes, flash memory cards, digital video disks, random access memories, read only memories, and the like, may also be used in the exemplary operating environment.

A number of program modules may be stored on the hard disk, external disk, ROM 722 or RAM 720, including an operating system (not shown), one or more application programs 7202, other program modules (not shown), and program data 7204. The application programs may include at least a part of the functionality as described above.

The computer 7 may be connected to VR system 50, input device 92 such as mouse and/or keyboard and display device 94 such as liquid crystal display, via corresponding I/O interfaces 80a to 80c and the system bus 82.

In addition to an implementation using a computer 7 as shown in FIG. 6, a part or all of the functionality of the exemplary embodiments described herein may be implemented as one or more hardware circuits. Examples of such hardware circuits may include but are not limited to: Large Scale Integration (LSI), Reduced Instruction Set Circuits (RISC). Application Specific Integrated Circuit (ASIC) and Field Programmable Gate Array (FPGA).

Some embodiments may include the above-described methods being written as one or more software components. These components, and the functionality associated with each, may be used by client, server, distributed, or peer computer systems. These components may be written in a computer language corresponding to one or more programming languages such as functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a tangible computer readable storage medium. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

A data source is an information resource. Data sources include sources of data that enable data storage and retrieval. Data sources may include databases, such as relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A network system, comprising a plurality of client devices and at least one central processing device, the at least one central processing device, comprising:
a central processing unit (CPU) configured to receive state data derived from streaming data, the streaming data relating to a plurality of client objects and being generated at one or more of the plurality of client devices, the state data relating to one or more of the plurality of client objects; and
a graphics processing unit (GPU) comprising a data store for storing one or more attributes of each client object, wherein the CPU is further configured to:
forward, to the GPU, the received state data as update information relating to said one or more of the plurality of client objects; and
wherein the GPU is configured to:
receive the update information from the CPU;
update the attributes in the data store using the update information, for each of said one or more of the plurality of client objects to which the update information relates;
perform, for each client object, rendering using the one or more attributes of the client object stored in the data store to display, on a display device, a plurality of image objects corresponding to the plurality of client objects.

2. The network system of claim 1, wherein the state data includes information indicating a state of each of said one or more of the plurality of client objects, and wherein the data store of the GPU further stores a state of each client object.

3. The network system of claim 2, wherein the plurality of client objects are the plurality of client devices, and wherein the state of each of said one or more of the plurality of client objects relates to network traffic to and from the client object.

4. The network system of claim 2, wherein the plurality of client objects correspond to users of the plurality of client devices, and wherein the state of each of said one or more of the plurality of client objects relate to one or more activities performed by the user corresponding to the client object.

5. The network system of claim 1, wherein the CPU is further configured to:
perform the forwarding of the received state data as the update information to the GPU in a predetermined time interval; and
include, in the update information to be forwarded to the GPU, for each of the one or more of the plurality of client objects, the information indicating the state of the client object and having been received latest during the predetermined time interval.

6. The network system of claim 1, wherein each of the plurality of image objects to be displayed on the display device comprises a plurality of polygons, wherein the one or more attributes of each client object include one or more of the following: position, color, size, distortion, texture, and wherein the GPU is further configured to, when performing said rendering, determining positions and orientations of the plurality of polygons of each of the plurality of image objects.

7. The network system of claim 1, further comprising a virtual reality headset, wherein the virtual reality headset includes the display device.

8. The network system of claim 1, further comprising:
an artificial intelligence (AI) engine configured to provide a user of the central processing device with information suggesting an action to be taken by the user based on the state data received by the CPU;
wherein the central processing device, further comprises:
an input device configured to receive one or more inputs from the user of the central processing device; and
wherein the AI engine is further configured to learn which action to suggest to the user, based on the one or more inputs from the user.

9. A computer implemented method, comprising:
receiving, by a central processing unit (CPU), state data derived from streaming data, the streaming data relating to a plurality of client objects and being generated at one or more of a plurality of client devices, the state data relating to one or more of the plurality of client objects;
forwarding, by the CPU to a graphics processing unit (GPU), comprising a data store for storing one or more attributes of each client object, the received state data as update information relating to the one or more of the plurality of client objects;
receiving, by the GPU, the update information from the CPU;
updating, by the GPU, the attributes in the data store using the update information, for each of the one or more of the plurality of client objects to which the update information relates;
performing, by the GPU, for each client object, rendering using the one or more attributes of the client object stored in the data store to display, on a display device, a plurality of image objects corresponding to the plurality of client objects.

10. The computer implemented method of claim 9, wherein the CPU performs said forwarding of the received state data as the update information to the GPU in a predetermined time interval, wherein the CPU includes, in the update information to be forwarded to the GPU, for each of the one or more of the plurality of client objects, the information indicating the state of the client object and having been received latest during the predetermined time interval.

11. The computer implemented method of claim 9, wherein each of the plurality of image objects to be displayed on the display device comprises a plurality of polygons, wherein the one or more attributes of each client object include one or more of the following: position, color, size, distortion and wherein, when performing said rendering, the GPU determines positions and orientations of the plurality of polygons of each of the plurality of image objects.

12. The computer implemented method of claim 9, further comprising:
providing, by an artificial intelligence (AI) engine, a user with information suggesting an action to be taken by the user based on the state data received by the CPU;
receiving, by an input device, one or more inputs from the user; and
learning, at the AI engine, which action to suggest to the user, based on the one or more inputs from the user.

13. A non-transitory computer readable storage medium tangibly storing instructions, which when executed by a computer, cause the computer to execute operations, comprising:
a central processing unit (CPU) configured to receive state data derived from streaming data, the streaming data relating to a plurality of client objects and being generated at one or more of the plurality of client devices, the state data relating to one or more of the plurality of client objects; and
a graphics processing unit (GPU) comprising a data store for storing one or more attributes of each client object, wherein the CPU is further configured to:
forward, to the GPU, the received state data as update information relating to said one or more of the plurality of client objects; and
wherein the GPU is configured to:
receive the update information from the CPU;
update the attributes in the data store using the update information, for each of said one or more of the plurality of client objects to which the update information relates;
perform, for each client object, rendering using the one or more attributes of the client object stored in the data store to display, on a display device, a plurality of image objects corresponding to the plurality of client objects.

14. The non-transitory computer readable storage medium of claim 13, wherein the state data includes information indicating a state of each of said one or more of the plurality of client objects, and wherein the data store of the GPU further stores a state of each client object.

15. The non-transitory computer readable storage medium of claim 14, wherein the plurality of client objects are the plurality of client devices, and wherein the state of each of said one or more of the plurality of client objects relates to network traffic to and from the client object.

16. The non-transitory computer readable storage medium of claim 14, wherein the plurality of client objects correspond to users of the plurality of client devices, and wherein the state of each of said one or more of the plurality of client objects relate to one or more activities performed by the user corresponding to the client object.

17. The non-transitory computer readable storage medium of claim 13, wherein the CPU is further configured to:
perform the forwarding of the received state data as the update information to the GPU in a predetermined time interval; and
include, in the update information to be forwarded to the GPU, for each of the one or more of the plurality of client objects, the information indicating the state of the client object and having been received latest during the predetermined time interval.

18. The non-transitory computer readable storage medium of claim 13, wherein each of the plurality of image objects to be displayed on the display device comprises a plurality of polygons, wherein the one or more attributes of each client object include one or more of the following: position, color, size, distortion, texture, and wherein the GPU is further configured to, when performing said rendering, determining positions and orientations of the plurality of polygons of each of the plurality of image objects.

19. The non-transitory computer readable storage medium of claim 13, further comprising a virtual reality headset, wherein the virtual reality headset includes the display device.

20. The non-transitory computer readable storage medium of claim 13, further comprising:
an artificial intelligence (AI) engine configured to provide a user of the central processing device with information suggesting an action to be taken by the user based on the state data received by the CPU;
wherein the central processing device, further comprises:
an input device configured to receive one or more inputs from the user of the central processing device; and
wherein the AI engine is further configured to learn which action to suggest to the user, based on the one or more inputs from the user.
